(19) United States
(12) Patent Application Publication
(10) Pub. No.: US 2011/0076411 A1
(43) Pub. Date: Mar. 31, 2011

(54) FLUID SUPPLY DEVICE FOR SPRAYING SYSTEM

(76) Inventor: Herbert Nussbaum, Freigericht 2 (DE)

(21) Appl. No.: 12/443,695

(22) PCT Filed: Aug. 28, 2007
(86) PCT No.: PCT/EP2007/058906

§ 371 Date: Dec. 9, 2010

(30) Foreign Application Priority Data
Oct. 9, 2006 (DE) 10 2006 048 037.6

(51) Int. Cl. B05D 1/02; B05B 7/24

(52) U.S. Cl. 427/421.1; 239/61; 239/1

(57) ABSTRACT

The present invention relates to a fluid supply device for a spraying system, comprising a first module (1) with two feed lines (50, 60) for paint, the lines being independent from each other and connected to a first color changer (100) with color valves (103, 104) disposed therein and circulation valves (105, 106), further comprising two lines that are independent from each other for the circulation of the paints (51, 61), the lines connecting a first color changer (100) to a second color changer (400) with release valves (401, 402) disposed therein. The color valves (103, 104) of the first color changer (100) are connected on the one hand via a common line (82) to a cleaning agent valve (101) and an air valve (102), and on the other hand are connected via a common pressure regulator line (55a, b) by a pressure regulator (200) disposed therein and a dosing pump (300) to the release valves (401, 402), a discharge valve (403) as well as a discharge line (56) of the second color changer (400). The invention further comprises a second module (2), having two lines (52, 62) that are independent from each other for feeding the paints to a third color changer (500) and/or a two-component mixer (510), wherein said lines comprise discharge valves (501, 503) and return lines (53, 63) and are disposed in the direct vicinity of a spraying system (77).

The present invention relates to a fluid supply for a sprayer, particularly for a paint or varnish sprayer, and a method of its use.

For a paint change in a sprayer, the system must be cleaned of the paint used, and subsequently, the new paint has to be put into use. To this end, when the pumps are on the outside, the feed lines to the atomizer and all the parts contained in them, such as paint changer, pressure regulator, or metering units, are cleaned with a cleaning fluid. In these methods, the paint contained in the line is discarded, which entails a high consumption of paint and cleaning fluid and a long flushing time.

Another method of cleaning feed lines is feeding the paint back into a ring line and then cleaning the feed lines with cleaning fluid. In these methods, it is true that the loss of paint when changing paints can be kept low, but the technical effort for control is very great, making such systems very liable to break down, and cost-intensive.

Proceeding from this state of the art and the disadvantages described in this connection, the object to be attained was therefore providing a sprayer that allows a rapid and efficient paint change, and, in this connection, makes do without a pigging system for the cleaning required for this. Furthermore, such a system should be characterized by low installation effort and cost.

According to the invention, this object is attained in that a fluid supply for a sprayer, particularly a paint or varnish sprayer, is composed of two modules.

The first module of the device according to the invention consists of:

at least two ring or supply lines for paint or varnish that are independent of one another and connected with the first paint changer provided with paint valves and circulation valves,

at least two lines for circulating respective paints or varnishes, that are independent of one another, and that extend from the first paint changer to a second paint changer provided with release valves,

where on the one hand the paint valves of the first paint changer are connected with a cleaning-agent valve and an air valve, by a common line, and on the other hand are connected with the release valves, a drain valve, as well as a drain line of the second paint changer, through a common pressure regulation line, through a pressure regulator and a metering pump.

The second module comprises at least two lines that are independent of one another for feeding the paints or varnishes from a second paint changer to a third paint changer and/or a two-component mixer, where the third paint changer and/or the two-component mixer has release valves and/or return lines for paints and varnishes, and is preferably provided in the immediate vicinity of the spraying device.

Such a system allows rapid and efficient automatic paint change, with the valve arrangement according to the invention allowing a low installation effort and cost for operation, and, in particular, for the cleaning that is required. Furthermore, no complicated pigging systems are used.

In the second module, the fluid supply according to the invention can optionally be equipped with any desired number of paint changers and/or two-component mixers. Fluids in the sense of the present invention are all fluids that can be used for surface treatment, particularly paints or varnishes. The device according to the invention thus makes it possible to transport a plurality of paints or varnishes, for example 20 or 30 paints or varnishes, separately from one another in the fluid supply. Cleaning fluid in the sense of the invention is understood to mean suitable solvents that can completely remove the paints and varnishes, in each instance. If a two-component mixer is present in the second module, it is advantageous to provide this module with a feed line for a hardener, the metering of the hardener being done by a valve referred to below as a hardener valve. Thus, it is possible to mix a hardener with the paint and/or varnish mixture. It is furthermore advantageous if the paint changer has circulation valves. It is advantageous if needle valves are used for the circulation valves, paint valves, and hardener valves, where the needle valves can be turn on and off pneumatically, through control lines. It is advantageous if the control takes place in computer-based manner, for example through a PLC system. In an advantageous embodiment of the fluid supply, the metering pump in the first module is connected with a cleaning agent line through a separate flushing valve; thus, this metering pump can be flushed with a cleaning agent, independently of the remaining system, where it is particularly advantageous if the metering pump is a flushable metering gear pump. In another advantageous embodiment, the first module is mounted outside of a cabin or on a cabin wall, and the second module is mounted on a robot or automatic varnishing machine.

A method according to the invention, for supplying fluid to a sprayer, particularly to a paint or varnish sprayer, is presented below:

In this connection, paints or varnishes are passed into the first paint changer provided with the paint valves and circulation valves, through at least two supply lines that are independent of one another. These paints or varnishes can be passed to a second paint changer provided with release valves through at least two separate lines for circulating the paints or varnishes. Furthermore, the paints or varnishes are passed from the second paint changer to a third paint changer and/or to a two-component mixer provided in a second module, through at least two lines, which are independent of one another. If it is practical, fundamentally two or more paint changers and/or two-component mixers as well as any desired combinations of these can also be provided in the second module. The paints can therefore constantly circulate through the system, in separate circuits, or can be optionally passed from the third paint changer and/or from the two-component mixer to a spraying device, when the valves are switched accordingly. In the cleaning mode, air and/or a fluid cleaning agent is/are passed through the first paint changer, through a common line with the pressure regulator, and a metering pump, through the second paint changer, through a drain valve, into a drain line. Furthermore, at the same time, air and/or a fluid cleaning agent is/are passed through the third paint changer and/or the two-component mixer and the spraying device. It is particularly practical for cleaning purposes to alternately pulse fluid cleaning agent and air through these components, with the shape of the pulse adapted to the fluid to be removed. If necessary, cleaning can also take place exclusively with a fluid cleaning agent, without air.

The fluid supply according to the invention furthermore has the advantages that in spite of the fact that the metering pump is outside, the paints circulate through the complete device, and circulation can be started or stopped. Furthermore, it is advantageous that a very slight loss of paint and cleaning agent occurs, that a rapid paint change is possible in spite of the pumps being outside, that there is simple and rapid access to all the components, and that the effort for the technology and the control structure is very low, as compared with a pigging system.

The fluid supply for a sprayer, according to the invention, can be used to coat a surface with a varnish, for example, preferably in a varnish coating system.

An illustrated embodiment of the invention is shown in the drawings and will be described in greater detail in the following. The drawing shows:

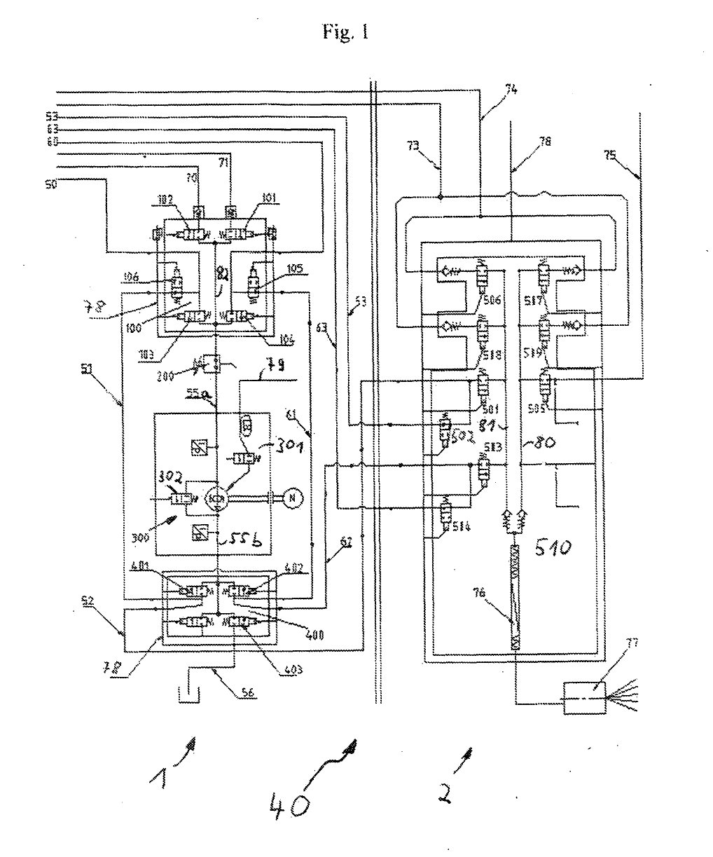

FIG. 1 is a media plan for a two-paint fluid supply having a two-component mixer that is mounted on a robot or an automatic varnishing machine,

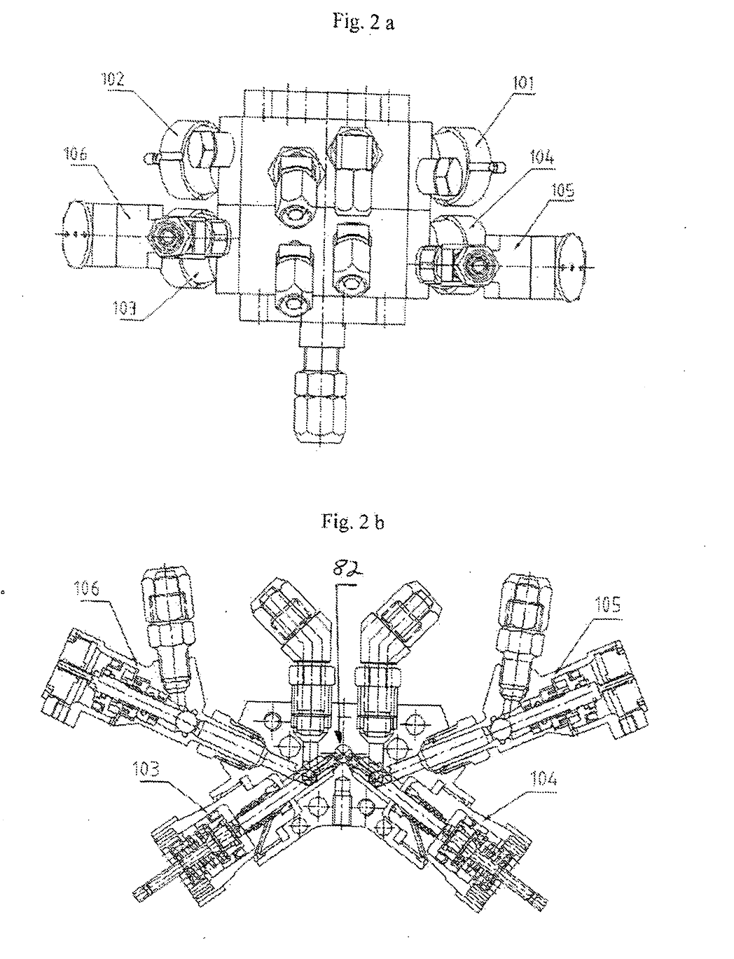

FIG. 2a, b a paint changer having circulation valves,

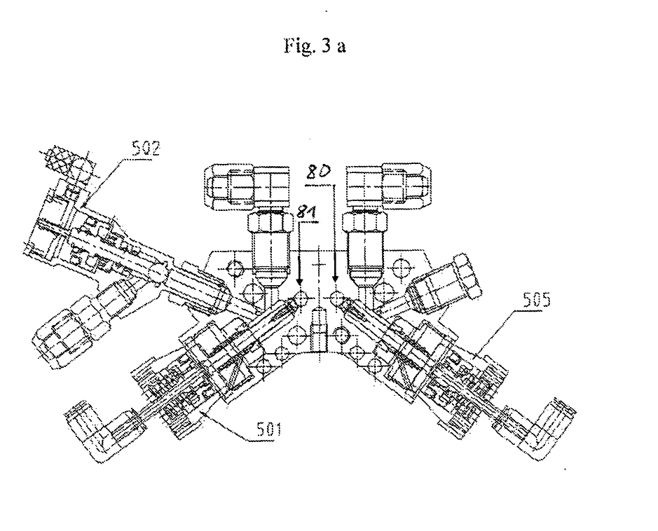

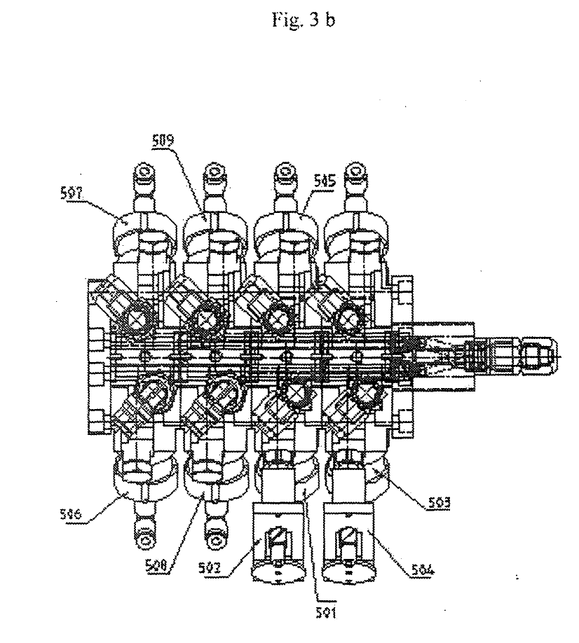

FIG. 3a, b a two-component mixer having circulation valves, and

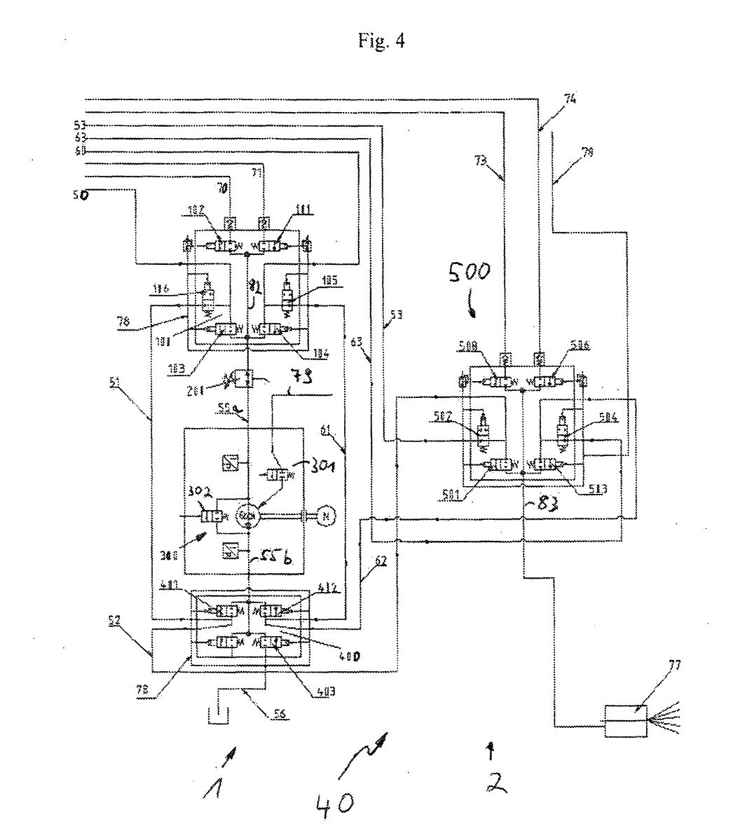

FIG. 4 a media plan for a fluid supply with two paints, having a paint changer that is mounted on a robot or an automatic varnishing machine.

FIG. 1 shows a fluid supply for a paint sprayer 40 for two paints, as an example. In this connection, the device consists of two modules 1 and 2, the first module 1 being mounted in a cabin wall, and the second module 2 being mounted on a robot or automatic varnishing machine. The two paints are passed into the first module 1 through two supply lines 50 and 60 for paints, which lines are independent of one another, and extend through paint valves 103 and 104 provided in the first paint changer 100, and to circulation valves 105 and 106 also in the first paint changer 100. Lines 51 and 61 for circulating the paints are connected to outputs of these circulation valves 105 and 106. These lines end at respective paint valves 401 and 402 of the second paint changer 400. The paints also can pass through these paint valves 401 and 402 and can then through release valves 501 and 503 provided in a two-component mixer 510 of the second module 1, through connected lines 52 and 62. The paints can then be passed back to the corresponding paint reservoirs, not shown in the drawing, through circulation valves 502, 504 and return lines 53 and 63 connected with them. Thus, the paints can circulate through the entire system.

In the two-component mixer 510 of the second module 2, as can also be seen in FIG. 1, the release valves 501 and 503 are connected through a short line 81 with a mixer 76 to which an atomizer 77 for applying paints to surfaces is connected. Furthermore, FIG. 1 shows how a hardener can be fed to the mixer 76 by a release valve 505 provided in the two-component mixer 510. In this connection, the hardener is moved through a line 75 and a pump, not shown in the drawing, and passed to the mixer 76 through a line 80. According to FIG. 1, two respective air-flush valves 508 and 509 and respective two cleaning-agent valves 506, 507 are furthermore built into the two-component mixer 510, which valves can be appropriately supplied with air and cleaning agent through feed lines 73 and 74.

All the valves in this embodiment shown in FIG. 1 are pneumatically turned on and/or off via control lines 78. In this connection, the control lines 78 shown always schematically indicate the all the individual control lines, since all the valves can be controlled separately.

As is furthermore evident from FIG. 1, the paint valves 103 and 104 in the first paint changer 100 are connected with a cleaning-agent valve 101 and an air valve 102 through a line 82, these valves being appropriately supplied with pulsed air and cleaning agent through the lines 70 and 71. Furthermore, a common line 55a leads from the paint valves 103 and 104 to a 6 ccm metering pump 300 through a pressure regulator 200. The metering pump 300 is furthermore connected with the release valves 401 and 402 of the second paint changer by a line 55b and is connected with a drain line 56 through a drain valve 403.

According to FIG. 1, the metering pump 300 is made as a flushable metering gear pump. This pump can be flushed with a cleaning agent through a flushing valve 301 and a separate line 79.

FIGS. 2a and 2b show the paint changer 100 for two paints, with its flow-through paint valves 103 and 104, the circulation valves 105 and 106, as well as the cleaning-agent valve 101 and the air valve 102. The common paint line 82 runs inside the paint changer 100. In this connection, the valves are needle valves and are screwed into the paint changer 100, thereby allowing easy replacement, if necessary.

FIGS. 3a and 3b show a two-component mixer 510 for two paints and a hardener, having the release valves 501 and 503 for the paints, and a release valve 505 for the hardener. The circulation valves 502 and 504, the cleaning-agent valves 506 and 507, and the air valves 508 and 509 are also screwed in. The paint line 81 and the hardener line 80 run inside the two-component mixer 510. In this connection, the valves are also needle valves.

FIG. 4 schematically shows a media plan for a fluid supply with two paints and having a paint changer 500, which is mounted on a robot or automatic varnishing machine. In this connection, the module 1 has the same construction as the device described under FIG. 1. Thus, the module 1 also contains a paint changer 100, a pressure regulator 200, a metering pump 300, and a second paint changer 400. In this illustrated embodiment, the lines 52 and 62 that lead away from the second paint changer 400 are passed through the release valves 501 and 503 provided in the paint changer 50 of the second module 2. The paints can then be returned to the corresponding paint reservoirs, not shown in the drawing, through circulation valves 502 and 504, and return lines 53 and 63 connected with them.

In the paint changer 500 of the second module 2, the release valves 501 and 503 are connected with an atomizer 77, through a short line 83, as can also be seen in FIG. 4.

According to FIG. 4, an air-flush valve 508 and a cleaning-agent valve 506 are furthermore built into the paint changer 500 and are supplied with air and cleaning agent through the respective feed lines 73 and 74. All the valves in this illustrated embodiment shown in FIG. 4 are also turned on and/or off pneumatically, through control lines 78.

In the following, it is described how fluid is supplied to a sprayer 40 according to the invention, having a two-component mixer 510 that is mounted on a robot or automatic varnishing machine. To this end, circulation of the two paints takes place, using a system according to FIG. 1, in that these paints are drawn from unillustrated reservoirs, pass through the closed paint valves 103 and 104, through the supply lines 50 and 60, and then through the open circulation valves 105 and 106 into the respective lines 51 and 61. The paints are then drawn from these lines through the closed paint valves 401 and 402, and also drawn through the closed paint valves 501, 502 through the lines 52 and 62. Circulation of the paints through the system is made complete with the return of the paints through the open circulation valves 502 and 504 and the lines 53 and 63. In a next switching possibility of the valves, a paint is supplied. To this end, a paint 1, for example, is pumped into a drain line 56, through the line 50, through the paint valve 103 that is now open, through the lines 82 and 55a, through the metering pump 300, through the line 55b, through the open drain valve 403 while the circulation valves 106 and 502 for the paint 1 are closed. Thus, the circulation of the paint 1 to the two-component mixer 510, through the second paint changer 400, is interrupted. While the paint is being supplied, the bypass valve 302 at the metering pump 300 is open, so that the paint can quickly be passed into the drain line 56, and is not limited, in terms of its flow, by the passage of the metering pump 300. When the section between the paint valve 103 all the way to the drain line 56 has been completely filled with paint 1, the drain valve 403 is closed. Subsequently, the paint valve 401 and the paint valve 501 can be opened at the same time, and the bypass valve 302 can be closed. Now, the paint 1 is metered into the mixer 76 through the metering pump 300, so that the paint exits from the atomizer 77. In this connection, charging of the paint takes place very rapidly, since only the section between the metering pump 300 and the pistol of the atomizer 77 has to be pressed down. When the paint is changed, the paint valves 103, 501 are closed, and the circulation valves 106 and 502 are opened so that the paint 1 is back in circulation mode again. For cleaning, air and a solvent are simply alternately flushed out of the drain valve 403, from the first paint changer 100, through the pressure regulator 200, and through the metering pump 300. Since this section is very short, cleaning can take place in a very short time and with a low consumption of solvent. At the same time, the section from the two-component mixer 510 all the way to the atomizer 77 is cleaned. Since this section is also very short, here again, cleaning can take place in a very short time and with a low consumption of solvent.

A fluid supply according to the sprayer shown in FIG. 4, having a paint changer 500 that is mounted on a robot or automatic varnishing machine, is operated in a manner analogous to the system shown in FIG. 1.

### REFERENCE SYMBOL LIST

1 first module
2 second module
40 paint sprayer
50 line for paint or varnish 1, supply
51 line for paint or varnish 1, circulation
52 line for paint or varnish 1, to the third paint changer or two-component mixer
53 line for paint or varnish 1, return
55a pressure regulator line, ahead of the metering pump
55b pressure regulator line, behind the metering pump
56 drain line
60 line for paint or varnish 2, supply
61 line for paint or varnish 2, circulation
62 line for paint or varnish 2, to the third paint changer or two-component mixer
63 line for paint or varnish 2, return
70 feed line, pulsed air
71 feed line, cleaning agent
73 feed line to robot or automatic varnishing machine, air
74 feed line to robot or automatic varnishing machine, cleaning agent
75 feed line, hardener
76 mixer element
77 spraying device or atomizer
78 control lines
79 cleaning agent line, metering pump
80 hardener line, in the two-component mixer
81 paint line, in the two-component mixer
82 paint line, in the first paint changer
83 paint line, in the third paint changer
100 first paint changer
101 cleaning-agent valve
102 air valve
103 paint valve, paint or varnish 1
104 paint valve, paint or varnish 2
105 circulation valve, paint or varnish 1
106 circulation valve, paint or varnish 2
200 pressure regulator
300 metering pump or metering gear pump, flushable
301 flushing valve for metering pump
302 bypass valve for metering pump
400 second paint changer
401 release valve, paint or varnish 1
402 release valve, paint or varnish 2
403 drain valve
500 third paint changer
501 release valve, paint or varnish 1
502 circulation valve, paint or varnish 1
503 release valve, paint or varnish 2
504 circulation valve, paint or varnish 2
505 release valve, hardener
506 cleaning-agent valve
507 cleaning-agent valve
508 air-flush valve
509 air-flush valve
510 two-component mixer

1. A fluid supply for a sprayer, particularly for a paint or varnish sprayer, comprising
a first module having
at least two independent paint or varnish supply lines that are connected with a first paint changer provided with paint valves and circulation valves,
at least two independent lines for circulating the paints or varnishes and connect a first paint changer with a second paint changer provided with release valves,
the paint valves of the first paint changer being connected on the one hand with a cleaning-agent valve and an air valve through a common line and on the other hand connected with the release valves, a drain valve, as well as a drain line of the second paint changer, through a common pressure regulator line, through a pressure regulator and a metering pump,
as well as a second module,
consisting of at least two independent lines for feeding the paints or varnishes from the second paint changer to a third paint changer or a two-component mixer , the third paint changer or the two-component mixer having release valves or return lines, and being provided in the vicinity of a spraying device.

2. The fluid supply according to claim 1 wherein a hardener valve is built into or screwed into the two-component mixer, which valve is connected with a feed line for a hardener.

3. The fluid supply according to claim 1 wherein the circulation valves are built into or screwed into the paint changers.

4. The fluid supply according to claim 1 wherein the circulation valves or paint valves are needle valves.

5. The fluid supply according to claim 1 wherein the metering pump is a flushable metering gear pump.

6. The fluid supply according to claim 1 wherein the circulation valves and the paint valves can be controlled through control lines.

7. The fluid supply according to claim 1 wherein the first module is mounted outside of a cabin or on a cabin wall.

8. The fluid supply according to claim 1 wherein the second module is mounted on a robot or automatic varnishing machine.

9. The fluid supply according to claim 1 wherein the metering pump is connected with a cleaning agent line through a separate flushing valve.

10. A method of supplying fluid to a sprayer according to claim 1, wherein
paints or varnishes are introduced in a first module into a first paint changer provided with paint valves and circulation valves through at least two independent supply lines for paints or varnishes,
the paints or varnishes are passed from the first [word/words missing] provided with release valves, through at least two lines for circulating the paints or varnishes, which lines are independent of one another, or from the first paint changer, through the second paint changer, through a drain valve, to a drain line, through a common line,
and are passed from the second paint changer to a third paint changer or to a two-component mixer provided in a second module, through at least two independent lines, and from there into an atomizer or into a separate return lines,
wherein, in the cleaning mode, air or a fluid cleaning agent is/are passed through the first paint changer, through a common line with the pressure regulator, and a metering pump, through the second paint changer, through a drain valve, into a drain line, and air or a fluid cleaning agent is/are passed through the third paint changer or the two-component mixer and the spraying device.

11. Use of the sprayer according to claim 1 for coating a surface with a varnish.
